(19) United States
(12) Patent Application Publication
(10) Pub. No.: US 2020/0132031 A1
(43) Pub. Date: Apr. 30, 2020

(54) Electronic Carburetor Injection

(71) Applicant: K&N Engineering, Inc., Riverside, CA (US)

(72) Inventor: Steve Williams, Cherry Valley, CA (US)

(73) Assignee: K&N Engineering, Inc., Riverside, CA (US)

(21) Appl. No.: 16/172,767

(22) Filed: Oct. 27, 2018

(51) Int. Cl. F02M 71/00; F02M 7/12; F02M 51/06; F02D 41/30

(52) U.S. Cl. CPC F02M 71/00; F02M 7/12; F02M 2700/1347; F02D 41/3005; F02M 51/06

(57) ABSTRACT

An electronic carburetor injection system is provided for an internal combustion engine. The electronic carburetor injection system is a standalone, user programmable fuel injection system that delivers additional fuel to the engine whenever a lean fuel/air mixture is delivered by a carburetor. The electronic carburetor injection system includes a fuel injector that delivers liquid fuel in the form of a spray discharge. A plate supports the fuel injector between the carburetor and an intake manifold of the engine. The plate includes an injector port that allows the spray discharge to enter the intake manifold without interfering with operating the carburetor. An engine control unit operates the fuel injector according to signals received from an oxygen sensor that is disposed within an exhaust system of the engine. During operation, the electronic carburetor injection system maintains the fuel/air mixture within a proper range across multiple driving conditions and changing environmental conditions.

### FIELD

The field of the present disclosure generally relates to fuel systems. More particularly, the field of the present disclosure relates to an electronic fuel injection system that operates in conjunction with a carburetor to maintain a fuel/air mixture to an engine within an optimal range across multiple driving conditions and changing environmental conditions.

### BACKGROUND

A carburetor generally blends air and fuel for combustion within an internal combustion engine. Typically, a carburetor comprises an open pipe, or throat, through which air is drawn into an intake of an internal combustion engine, and a throttle valve to control the airflow through the carburetor. The throttle valve typically is of a butterfly variety, comprising a rotatable disk within the throat of the carburetor and in operative communication with a throttle control of the engine. The butterfly valve may be rotated within the throat between a first extremal position wherein the valve obstructs a large portion of the airflow into the intake and a second extremal position wherein the butterfly valve offers very little resistance to incoming air, thereby allowing a maximal airflow into the intake.

A Venturi positioned above the butterfly valve generally comprises a narrow section within the throat wherein airflow through the carburetor increases in speed. Fuel is introduced into the airflow through small holes at the narrowest part of the Venturi. Fuel flow into the airflow is adjusted by way of precisely calibrated orifices, referred to as jets, positioned within a fuel reservoir, called a fuel bowl. During operation, engine power and speed may be controlled by way of the butterfly valve, whereby positioning the butterfly valve at the first extremal position limits the quantity of air and fuel introduced into the engine, and positioning the throttle valve at the second extremal position allows a maximal quantity of air and fuel into the engine.

The fuel bowl typically comprises a float chamber which maintains a quantity of fuel at near-atmospheric pressure, ready for use. The float chamber is constantly replenished by way of a fuel pump which supplies fuel through an inlet valve. An advantageous fuel level is maintained within the fuel bowl by way of a float controlling the inlet valve. As fuel is drawn into the engine through the Venturi, the quantity of fuel in the float chamber decreases, causing the float to drop within float chamber, thereby opening the inlet valve and allowing fuel to enter the float chamber. As the fuel level rises, the float rises within the float chamber until the inlet valve is closed. Generally, ventilation tubes are used to allow atmospheric pressure to be maintained in the float chamber as the fuel level changes. The ventilation tubes typically extend from the float chamber into the carburetor throat.

In general, a carburetor must measure the airflow entering an engine, deliver a correct amount of fuel to maintain a fuel/air mixture within a proper range, and provide the mixture while maintaining optimized fuel economy and low emissions. A drawback to conventional carburetors, however, is that it can be difficult to adjust the carburetor to deliver the fuel/air mixture within the proper range during a wide variety of driving conditions and changing environmental factors such as atmospheric pressure and temperature. For example, the carburetor must be capable of delivering the fuel/air mixture during cold starting the engine, hot starting the engine, idling or slow-running, acceleration, high speed or high power at full throttle, as well as cruising or pulling light loads at partial throttle. Carburetors typically contain a complex set of mechanisms, called circuits, that provide the proper fuel/air mixture during different modes of engine operation. A drawback to utilizing multiple circuits, however, is that performance may suffer, at least momentarily, during switching circuits as driving conditions change, such as due to increasing speed and decreasing power requirements.

What is needed, therefore, is an electronic fuel injection system that operates in conjunction with an existing carburetor to ensure that the fuel/air mixture being delivered to the engine is always within an optimal range.

### SUMMARY

An electronic carburetor injection system is provided for delivering supplemental fuel to a carburetor-aspirated internal combustion engine. The electronic carburetor injection system is a standalone fuel injection system that may be programmed by an end-user to deliver additional fuel to the engine whenever the fuel/air mixture delivered by the carburetor is found to be lacking sufficient fuel to support a desired combustion within the engine. In an embodiment, the electronic carburetor injection system includes a fuel injector that delivers liquid fuel in the form of a spray discharge. A plate supports the fuel injector between the carburetor and an intake manifold of the engine. The plate includes an injector port that allows the spray discharge to enter the intake manifold without interfering with operation of the carburetor. An oxygen sensor is disposed within an exhaust system of the engine and configured to detect an oxygen content of exhaust gases exiting the engine. An engine control unit operates the fuel injector according to signals received from the oxygen sensor.

In an exemplary embodiment, an electronic carburetor injection system for an internal combustion engine comprises: a fuel injector that delivers liquid fuel in the form of a spray discharge; a plate that supports the fuel injector between a carburetor and an intake manifold; an oxygen sensor disposed within an exhaust system of the engine; and an engine control unit configured to operate the fuel injector according to signals received from at least the oxygen sensor.

In another exemplary embodiment, the electronic carburetor injection system is a standalone fuel injection system that supplements a fuel/air mixture delivered to the engine by way of the carburetor. In another exemplary embodiment, the electronic carburetor injection system delivers a measured portion of additional fuel to the engine whenever a fuel/air mixture delivered by the carburetor is found to be lacking sufficient fuel to support a desired combustion of the fuel/air mixture within the engine. In another exemplary embodiment, coupling the electronic carburetor injection system with the carburetor operates to maintain a fuel/air mixture within a proper range across a multiplicity of driving conditions and changing environmental conditions. In another exemplary embodiment, the electronic carburetor injection system may be configured to assist with cold starting the engine by operating for a temporary, predetermined time period following starting the engine. In another exemplary embodiment, the electronic carburetor injection system may be programmed by an end-user to operate whenever a fuel/air mixture delivered by the carburetor is found to be leaner than a specific value.

In another exemplary embodiment, the plate is a generally solid member having a uniform thickness that is suitable for being fastened between the carburetor and the intake manifold. In another exemplary embodiment, the plate is comprised of a rigid material that is capable of withstanding being fastened between the carburetor and the intake manifold, as well as tolerating engine operating temperatures and contact with liquid fuel.

In another exemplary embodiment, the plate includes a central opening that allows a fuel/air mixture delivered by the carburetor to pass through the plate and enter the intake manifold. In another exemplary embodiment, the plate is configured to support the fuel injector in a location that facilitates operating the fuel injector without interfering with normal operation of the carburetor. In another exemplary embodiment, the opening includes an injector port that allows the spray discharge to enter the intake manifold.

In another exemplary embodiment, a fuel circuit may be implemented whereby a fuel pump cooperates with a fuel pressure regulator to deliver high-pressure fuel to the fuel injector, and wherein unused fuel is directed back to a fuel tank at a relatively low pressure. In another exemplary embodiment, the fuel pressure regulator and the fuel pump cooperate to maintain high-pressure fuel delivery to the fuel injector by way of a fuel inlet port disposed on a fuel feel block coupled with the plate.

In another exemplary embodiment, the oxygen sensor is a wide-band O₂ sensor that is suitable for being placed into contact with exhaust gases exiting the internal combustion engine during operation. In another exemplary embodiment, a sensor cable facilitates sensor data indicating the oxygen content of the exhaust gases being received by the engine control unit. In another exemplary embodiment, an actuator cable facilitates operation of the fuel injector by way of signals sent by the engine control unit.

In another exemplary embodiment, the engine control unit is configured to control the operation of the fuel injector in cooperation with a fuel/air mixture delivered by the carburetor. In another exemplary embodiment, the fuel/air mixture is determined by way of an oxygen sensor in contact with exhaust gases exiting the internal combustion engine during operation. In another exemplary embodiment, the engine control unit includes a fixed programming that is based upon a particular application of the internal combustion engine. In another exemplary embodiment, the engine control unit is configured to be programmable by an end-user.

### BRIEF DESCRIPTION OF THE DRAWINGS

The drawings refer to embodiments of the present disclosure in which:

FIG. 1 illustrates an exploded view of an exemplary embodiment of an electronic carburetor injection system that is coupled with a carburetor and an air filter, according to the present disclosure;

FIG. 2 illustrates an isometric view of an exemplary embodiment of a plate for supporting a fuel injector between a carburetor and an intake manifold of an engine in accordance with the present disclosure; and

FIG. 3 illustrates a close-up view of a fuel injector coupled with the plate of FIG. 2 by way of a fuel feed block, according to the present disclosure.

While the present disclosure is subject to various modifications and alternative forms, specific embodiments thereof have been shown by way of example in the drawings and will herein be described in detail. The invention should be understood to not be limited to the particular forms disclosed, but on the contrary, the intention is to cover all modifications, equivalents, and alternatives falling within the spirit and scope of the present disclosure.

### DETAILED DESCRIPTION

In the following description, numerous specific details are set forth in order to provide a thorough understanding of the present disclosure. It will be apparent, however, to one of ordinary skill in the art that the invention disclosed herein may be practiced without these specific details. In other instances, specific numeric references such as “first injector,” may be made. However, the specific numeric reference should not be interpreted as a literal sequential order but rather interpreted that the “first injector” is different than a “second injector.” Thus, the specific details set forth are merely exemplary. The specific details may be varied from and still be contemplated to be within the spirit and scope of the present disclosure. The term “coupled” is defined as meaning connected either directly to the component or indirectly to the component through another component. Further, as used herein, the terms “about,” “approximately,” or “substantially” for any numerical values or ranges indicate a suitable dimensional tolerance that allows the part or collection of components to function for its intended purpose as described herein.

In general, the present disclosure describes an electronic carburetor injection system for delivering additional fuel to a carburetor-aspirated internal combustion engine whenever a fuel/air mixture delivered by the carburetor lacks sufficient fuel to support optimal combustion within the engine. The electronic carburetor injection system is a standalone fuel injection system that may be programmed by an end-user. In an embodiment, the electronic carburetor injection system includes a fuel injector that delivers liquid fuel in the form of a spray discharge. A plate supports the fuel injector between the carburetor and an intake manifold of the engine. An oxygen sensor is disposed within an exhaust system of the engine and configured to detect an oxygen content of exhaust gases exiting the engine. An engine control unit operates the fuel injector according to signals received from the oxygen sensor. As such, the electronic carburetor injection system operates to maintain the fuel/air mixture within a proper range across a multiplicity of driving conditions and changing environmental conditions.

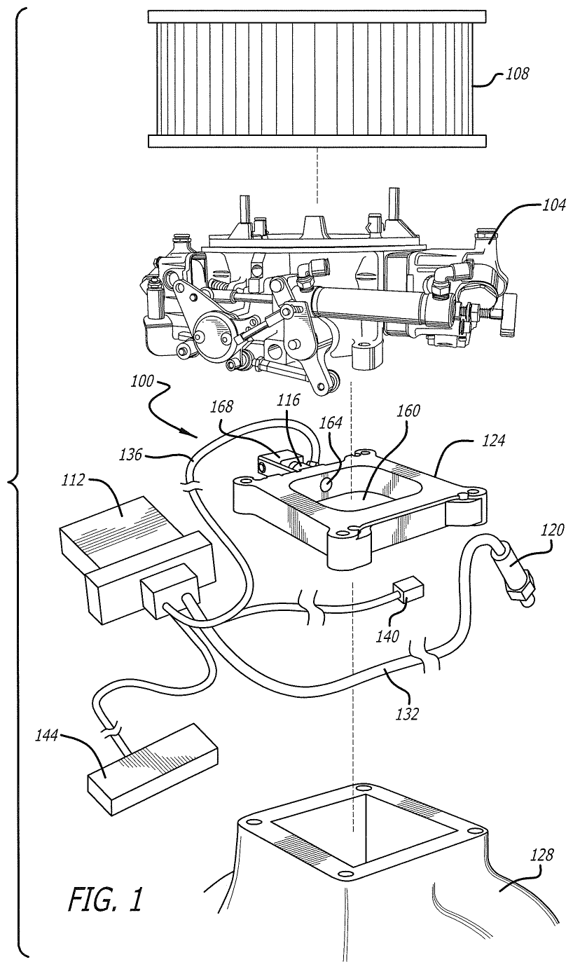

FIG. 1 illustrates an exemplary embodiment of an electronic carburetor injection system 100 that is coupled with a carburetor 104 and an air filter 108, according to the present disclosure. The carburetor 104 and air filter 108 are purely exemplary in nature and should be understood to be typical of those conventional components found on a wide variety of internal combustion engines, particularly older automobiles and trucks, as well as engines utilized for performance and racing purposes. The system 100 essentially is a standalone fuel injection system that may supplement a fuel/air mixture delivered to an engine by way of the carburetor 104. In operation, the system 100 may advantageously deliver a measured portion of additional fuel to the engine whenever the fuel/air mixture delivered by the carburetor 104 is found to be “lean,” or lacking sufficient fuel to support an optimal, or desired combustion of the fuel/air mixture within the engine. As such, coupling the system 100 with the carburetor 104 operates to maintain the fuel/air mixture within a proper range across different driving conditions and changing environmental conditions such as atmospheric pressure, temperature, and air density.

As shown in FIG. 1, the system 100 includes an engine control unit (ECU) 112 that may be coupled with a fuel injector 116 and an oxygen sensor 120. The fuel injector 116 is supported by way of a plate 124 that may be disposed between the carburetor 104 and an intake manifold 128 of the engine. The plate 124 supports the fuel injector 116 in a location beneath the carburetor 104 that is advantageous for delivering additional fuel into the intake manifold 128 to supplement the fuel/air mixture being delivered to the engine by the carburetor 104. It will be appreciated that positioning the fuel injector 116 below the carburetor 104 facilitates operating the fuel injector without interfering with normal operation of the carburetor 104. Thus, the plate 124 advantageously simplifies installing the system 100 onto carburetor-aspirated engines.

The oxygen sensor 120 may be of a typical automotive variety, such as a wide-band O₂ sensor, that is best suited for being placed into contact with exhaust gases exiting the engine during operation. As will be appreciated, an abundance of oxygen in the exhaust gases indicates a lean fuel/air mixture whereas a lack of oxygen indicates a rich fuel/air mixture comprising an overabundance of fuel being delivered into the intake manifold 128. With the oxygen sensor 120 installed into an exhaust system coupled with the engine, sensor data indicating the oxygen content of the exhaust gases may be received by the ECU 112 from the oxygen sensor 120 by way of a sensor cable 132.

With continuing reference to FIG. 1, an actuator cable 136 facilitates operation of the fuel injector 116 by way of signals sent by the ECU 112. During operation, the ECU 112 may increase the amount of liquid fuel being delivered to the intake manifold 128 by the fuel injector 116 when the oxygen sensor 120 indicates a lean fuel/air mixture. Alternatively, when a rich fuel/air mixture is detected, the ECU 112 may reduce, or cease, the amount of liquid fuel delivered by the fuel injector 116. It is contemplated that, in some embodiments, however, the ECU 112 may actuate the fuel injector 116 only when the lean fuel/air mixture is detected.

In some embodiments, the actuator cable 136 may include a fuel pump actuator cable 140 to facilitate coupling the ECU 112 with a fuel pump (not shown) suitable for use with the system 100. As will be appreciated, operation of the fuel injector 116 may require a fuel pressure that is greater than the fuel pressure supplied to the carburetor 104. As such, the fuel pump actuator cable 140 may be connected to a high-pressure fuel pump that may be operated by way of signals from the ECU 112. In some embodiments, the fuel pump may maintain a steady, high pressure fuel supply to the fuel injector 116. In some embodiments, a fuel circuit may be implemented whereby a fuel pressure regulator cooperates with the fuel pump to maintain high pressure fuel supplied to the fuel injector 116, and wherein unused fuel in the fuel circuit is returned to a fuel tank.

With reference to FIG. 1, the ECU 112 generally is configured to control the operation of the fuel injector 116 in cooperation with the fuel/air mixture delivered by the carburetor 104. The ECU 112 generally may be comprised of one or more microprocessors that can process input signals received from one or more engine sensors, such as the oxygen sensor 120, in real-time. As will be appreciated, the ECU 112 may include hardware comprising electronic components on a printed circuit board (PCB), ceramic substrate or a thin laminate substrate, and include a micro controller chip (CPU). Software may be stored in the microcontroller or other chips on the PCB, such as EPROMs or flash memory, so that the CPU can be re-programmed by uploading updated code or replacing chips.

In some embodiments, the ECU 112 may have a fixed programming, such as a fuel table or a fuel map, that is based upon the particular engine application for which the system 100 is intended to be used. It is contemplated, however, that in some other embodiments the ECU 112 may be programmable by an end-user of the system 100. As will be appreciated, the programmable ECU 112 advantageously allows the end-user to tailor the operation of the system 100 based on the condition of the engine. The condition of the engine may be affected by any of various aftermarket modifications that may have been added to the engine, such as, by way of non-limiting example, adding or changing any of a turbocharger, an intercooler, the exhaust system, or a conversion to run on an alternative fuel. It is contemplated that the end-user may program the ECU 112 to control the amount of fuel delivered by the fuel injector 116 to the engine, and thus the end-user may tailor the performance of the engine as desired.

Signal connectors 144 facilitate coupling the ECU 112 with various input sensors that may be installed on the engine, as well as coupling the ECU with any gauges that may be configured to display engine management information to the end-user. For example, in an embodiment, the signal connectors 144 may facilitate passing engine temperature and speed data to the ECU 112. The ECU 112 may output a resultant fuel/air mixture readout that may be displayed to the end-user, such as by way of a gauge located on an instrument cluster of the vehicle. Further, the signal connectors 144 may facilitate connecting the ECU 112 to an electrical system of the vehicle, such as circuitry coupled with positive and negative terminals of an onboard battery.

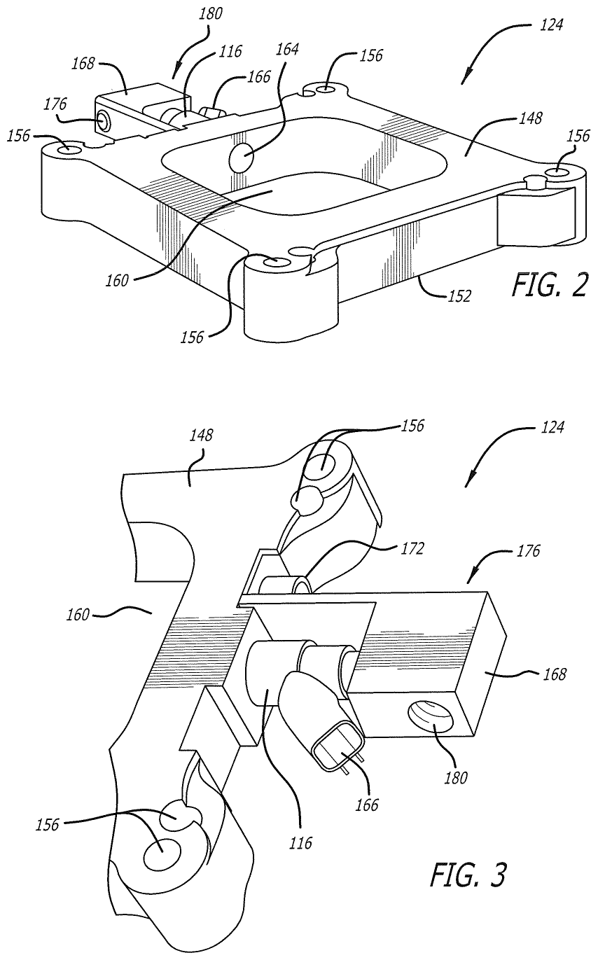

FIG. 2 illustrates an isometric view of the plate 124 for supporting the fuel injector 116 as described herein. The plate 124 is a generally solid member having a uniform thickness that is suitable for being fastened between the carburetor 104 and the intake manifold 128. The plate 124 may be comprised of any rigid material, such as billet aluminum, that is capable of withstanding being fastened between the carburetor 104 and the intake manifold 128, as well as tolerating engine operating temperatures and contact with liquid fuel. An upper surface 148 of the plate 124 may be coupled with a mounting surface of the carburetor 104 by way of a gasket or other suitable sealing device. Similarly, a lower surface 152 of the plate may be coupled with a mounting surface of the intake manifold 128 by way of a gasket or other suitable sealing device.

One or more mounting holes 156 are disposed in corner portions of the plate 124 and preferably aligned with threaded holes in the mounting surface of the intake manifold 128. Multiple mounting holes 156 may be included in each corner portion of the plate 124 so as to accommodate the locations of the threaded holes in different, popular intake manifolds 128. In some embodiments, threaded studs may be fixated in the threaded holes of the intake manifold 128 such that the studs extend upward through the mounting holes 156, beyond the upper surface 148, when the plate 124 is placed onto the intake manifold 128. In such embodiments, the carburetor 104 may be placed onto the plate 124 and nuts may be threadably engaged with the ends of the threaded studs and tightened to fasten the carburetor 104 and the plate 124 onto the intake manifold 128. In another embodiment, however, the plate 124 and carburetor 104 may be placed onto the intake manifold 128 and threaded bolts may be inserted through mounting holes of the carburetor, extended through the mounting holes 156 and tightened into the threaded holes in the intake manifold 128.

As shown in FIG. 2, the plate 124 includes a central opening 160 that is configured to allow the fuel/air mixture delivered by the carburetor 104 to pass through the plate 124 and enter the intake manifold 128. The opening 160 preferably has a shape and a size that are substantially similar to at least the shape and size of an opening in the intake manifold 128. In some embodiments, the shape and size of the opening 160 may match both the opening in the intake manifold 128 and an opening in a bottom portion of the carburetor 104. As will be appreciated, matching the opening 160 to the openings in the carburetor 104 and the intake manifold 128 minimizes obstruction and turbulence of the fuel/air mixture passing between the carburetor 104 and the intake manifold 128, and thus generally improves engine performance.

As shown in FIG. 2, the opening 160 includes an injector port 164 that allows a spray discharge of fuel from the fuel injector 116 to enter the opening 160. A fuel injector controller connection 166 receives the actuator cable 136 and enables the ECU 112 to operate the fuel injector 116, as described herein. During instances of a lean fuel/air mixture delivery by the carburetor 104, the fuel injector 116 may be operated to spray additional fuel into the opening 160. The quantity of additional fuel delivered may be metered to ensure that the fuel/air mixture entering the intake manifold 128 is within a proper, desired range, as described herein. It should be understood, however, that the fuel injector 116 is not limited to being operated solely during instances of a lean fuel/air mixture entering the engine, but rather the fuel injector, and more broadly the system 100, may be configured to cooperate with the carburetor 104 to provide any desired level of engine performance.

As best shown in FIG. 3, the fuel injector 116 may be coupled with the plate 124 by way of a fuel feed block 168. A suitable fastener 172, such as a bolt threadably engaged in a hole, may be used to attach the fuel feed block 168 to the plate 124. In an embodiment, a fuel metering end of the fuel injector 116 is press-fitted into the injector port 164, and a fuel inlet end of the fuel injector 116 is press-fitted into the fuel feed block 168. Any of various seals, such as suitably sized O-rings, may be utilized to provide fluid-tight couplings between the fuel injector 116, the plate 124 and the fuel feed block 168.

The fuel feed block 168 preferably includes a fuel inlet port 176 and a fuel outlet port 180 that are both in fluid communication with the fuel inlet end of the fuel injector 116. In general, the fuel inlet port 176 may receive a fuel line that provides liquid fuel from a fuel tank, and the fuel outlet port 180 may receive a fuel line that directs unused liquid fuel back to the fuel tank. In the illustrated embodiment, however, the fuel outlet port 180 includes a threaded opening that may be used to receive a fuel pressure regulator. As mentioned hereinabove, a fuel circuit may be implemented whereby a fuel pump cooperates with the fuel pressure regulator to deliver high pressure fuel to the fuel injector 116, and unused fuel is circulated back to the fuel tank. Thus, in a fuel circuit implementation, the fuel pressure regulator and the fuel pump maintain high-pressure fuel delivery to the fuel injector 116 by way of the fuel inlet port 176. The unused fuel is returned to the fuel tank under a relatively low pressure after exiting through the fuel outlet port 180 and passing through the fuel pressure regulator.

As disclosed hereinabove, the system 100 generally is a standalone fuel injection system that cooperates with an existing carburetor 104 to provide an advantageous fuel/air mixture to an internal combustion engine. In some embodiments, the system 100 may deliver a measured portion of additional fuel to the engine whenever the fuel/air mixture delivered by the carburetor 104 is found to be lacking sufficient fuel to support an optimal, or desired combustion of the fuel/air mixture within the engine. It should be understood, however, that the system 100 is not limited to being operated solely during instances of a lean fuel/air mixture entering the engine, but rather the system 100 may be configured to cooperate with the carburetor 104 to provide any desired level of engine performance. In some embodiments, for example, the system 100 may be configured to assist with cold starting the engine by operating temporarily for a predetermined time period following starting the engine. In some embodiments, however, the system 100 may be programmed by an end-user to operate whenever the fuel/air mixture is found to be leaner than a specific value, as desired. It is contemplated, therefore, that the system 100 effectively combines advantages of the carburetor 104 with the advantages of an electronic fuel injection (EFI), and thus the system 100 is particularly advantageous for racing implementations wherein specific fuel/air mixtures may be desirably programmed for optimal engine performance.

While the invention has been described in terms of particular variations and illustrative figures, those of ordinary skill in the art will recognize that the invention is not limited to the variations or figures described. In addition, where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially as described above. To the extent there are variations of the invention, which are within the spirit of the disclosure or equivalent to the inventions found in the claims, it is the intent that this patent will cover those variations as well. Therefore, the present disclosure is to be understood as not limited by the specific embodiments described herein, but only by scope of the appended claims.

What is claimed is:

1. An electronic carburetor injection system for an internal combustion engine, comprising:
a fuel injector that delivers liquid fuel in the form of a spray discharge;
a plate that supports the fuel injector between a carburetor and an intake manifold;
an oxygen sensor disposed within an exhaust system of the engine; and
an engine control unit configured to operate the fuel injector according to signals received from at least the oxygen sensor.

2. The system of claim 1, wherein the electronic carburetor injection system is a standalone fuel injection system that supplements a fuel/air mixture delivered to the engine by way of the carburetor.

3. The system of claim 1, wherein the electronic carburetor injection system delivers a measured portion of additional fuel to the engine whenever a fuel/air mixture delivered by the carburetor is found to be lacking sufficient fuel to support a desired combustion of the fuel/air mixture within the engine.

4. The system of claim 1, wherein coupling the electronic carburetor injection system with the carburetor operates to maintain a fuel/air mixture within a proper range across a multiplicity of driving conditions and changing environmental conditions.

5. The system of claim 1, wherein the electronic carburetor injection system may be configured to assist with cold starting the engine by operating for a temporary, predetermined time period following starting the engine.

6. The system of claim 1, wherein the electronic carburetor injection system may be programmed by an end-user to operate whenever a fuel/air mixture delivered by the carburetor is found to be leaner than a specific value.

7. The system of claim 1, wherein the plate is a generally solid member having a uniform thickness that is suitable for being fastened between the carburetor and the intake manifold.

8. The system of claim 1, wherein the plate is comprised of a rigid material that is capable of withstanding being fastened between the carburetor and the intake manifold, as well as tolerating engine operating temperatures and contact with liquid fuel.

9. The system of claim 1, wherein the plate includes a central opening that allows a fuel/air mixture delivered by the carburetor to pass through the plate and enter the intake manifold.

10. The system of claim 9, wherein the plate is configured to support the fuel injector in a location that facilitates operating the fuel injector without interfering with normal operation of the carburetor.

11. The system of claim 9, wherein the opening includes an injector port that allows the spray discharge to enter the intake manifold.

12. The system of claim 1, wherein a fuel circuit may be implemented whereby a fuel pump cooperates with a fuel pressure regulator to deliver high-pressure fuel to the fuel injector, and wherein unused fuel is directed back to a fuel tank at a relatively low pressure.

13. The system of claim 12, wherein the fuel pressure regulator and the fuel pump cooperate to maintain high-pressure fuel delivery to the fuel injector by way of a fuel inlet port disposed on a fuel feel block coupled with the plate.

14. The system of claim 1, wherein the oxygen sensor is a wide-band O₂ sensor that is suitable for being placed into contact with exhaust gases exiting the internal combustion engine during operation.

15. The system of claim 1, wherein a sensor cable facilitates sensor data indicating the oxygen content of the exhaust gases being received by the engine control unit.

16. The system of claim 1, wherein an actuator cable facilitates operation of the fuel injector by way of signals sent by the engine control unit.

17. The system of claim 1, wherein the engine control unit is configured to control the operation of the fuel injector in cooperation with a fuel/air mixture delivered by the carburetor.

18. The system of claim 17, wherein the fuel/air mixture is determined by way of an oxygen sensor in contact with exhaust gases exiting the internal combustion engine during operation.

19. The system of claim 1, wherein the engine control unit includes a fixed programming that is based upon a particular application of the internal combustion engine.

20. The system of claim 1, wherein the engine control unit is configured to be programmable by an end-user.
